(19) United States
(12) Patent Application Publication
(10) Pub. No.: US 2004/0234278 A1
(43) Pub. Date: Nov. 25, 2004

(54) Management system, machine management apparatus, maintenance work instructing method, recording medium and computer data signal

(76) Inventors: Minoru Saitoh, Kanagawa (JP); Yoshiaki Ohno, Kanagawa (JP); Yasuyuki Shirai, Tokyo (JP)

Correspondence Address: MORRISON & FOERSTER LLP, 1650 TYSONS BOULEVARD, SUITE 300, MCLEAN, VA, 22102, US

(21) Appl. No.: 10/809,825

(22) Filed: Mar. 26, 2004

(30) Foreign Application Priority Data
Mar. 28, 2003 (JP) 2003-92755

(51) Int. Cl. G03G 15/00

(52) U.S. Cl. 399/8

(57) ABSTRACT

A printing machine generates use information including the number of printouts made in a printing operation, and transmits the generated use information to a management apparatus. A machine information data base stores old use information of the printing machine and a threshold value of a predetermined number of printouts in association with the printing machine. Upon reception of the use information sent from the printing machine, a machine management server stores the use information in the machine information data base and counts up the number of printouts of the printing machine. When the counted number of printouts exceeds the threshold value stored in the machine information data base, it is determined that preventive maintenance for the printing machine is needed. When it is determined that preventive maintenance is necessary, the machine management server sends instruction information instructing preventive maintenance to the maintenance terminal.

### BACKGROUND OF THE INVENTION

1. Field of the Invention

The present invention relates to a management system, a machine management apparatus, a maintenance work instructing method, a recording medium and a computer data signal.

2. Description of the Related Art

Printing machines such as copying machines and printers have been introduced into offices to improve the efficiency of office works. Copying machines are placed, for example, department by department in an office and are used to make copies of documents needed by users (workers). Printers are placed, for example, work group by work group in a department to print out files or so output by users from terminals (personal computers or so).

Recently, there is known a printing machine called “multifunction machine” which has not only a copying function but also a scanner function and a printer function or so. This multifunction machine can print out predetermined files or so as well as copy manuscripts and can serve as a scanner to scan a manuscript and acquire image data.

Recently, those various kinds of printing machines are connected to one another over a LAN (Local Area Network) or so, allowing user terminals to output print data or so to the individual printing machines.

Some technique which manages information on the amount of usage of printing machines connected to one another over such a LAN has been contemplated, as disclosed on, for example, page 9-17 and in FIG. 1 of Unexamined Japanese Patent Application KOKAI Publication No. 2001-250008.

It is desirable that the aforementioned printing machines should be usable anytime without troubles in offices or so. Therefore, it is often the case that maintenance contracts for printing machines are made with makers or so. Maintenance persons do regular maintenance works on printing machines to improve the availability factor.

Even with a regular maintenance work done, however, in such a case where the use conditions for printing machines are changed, various troubles are likely to occur. When the rate of usage of printing machines in an office increases rapidly, for example, the degradation, wear-out or so of parts is accelerated, leading to the occurrence of an unexpected trouble.

When a trouble actually occurs, a person in charge or so in an office requests the maintenance department of a maker or so to deal with the trouble, so that recovery from the trouble would take some time. This results in a considerable reduction in the availability factor of the printing machine.

If there is only a single printing machine in an office, for example, no printing (copy and printout) is possible until the trouble is cleared, hindering the works.

Therefore, there have been demands of a further improvement on the availability factor of printing machines and some effective way to handle troubles when occurred.

### SUMMARY OF THE INVENTION

Accordingly, it is an object of the present invention to provide a management system, a machine management apparatus, a maintenance work instructing method, a recording medium and a computer data signal which can adequately improve the availability factor of printing machines by instructing necessary maintenance.

To achieve the object, according to the first aspect of the invention, there is provided a management system comprising a printing machine, a management apparatus and a maintenance terminal connected to one another over an external network.

In the management system, the printing machine generates use information indicating contents of a printing operation and transmits the generated use information to the management apparatus, and

the management apparatus receives the use information sent from the printing machine, discriminates whether preventive maintenance for the printing machine is needed or not in accordance with the received use information, and transmits instruction information instructing preventive maintenance to the maintenance terminal when it is discriminated that the preventive maintenance is needed.

This management system can adequately improve the availability factor of printing machines by instructing necessary maintenance.

The use information generated by the printing machine may include number-of-printouts information indicating a number of sheets printed by the printing operation, and

the management apparatus may memorize a threshold value of a predetermined number of printouts in association with the printing machine, and discriminate whether or not preventive maintenance for the printing machine is needed based on a quantity indicated by the number-of-printouts information included in the use information received by the management apparatus and the threshold value memorized by the management apparatus.

The management apparatus may memorize maintenance field information indicating a field of maintenance which is carried out by a maintenance person who uses a maintenance terminal, specify the maintenance terminal of the maintenance person who maintains the printing machine, when it is discriminated that the preventive maintenance is needed, based on contents of the preventive maintenance discriminated as necessary and the maintenance field information, and transmit instruction information to the specified maintenance terminal.

According to the second aspect of the invention, there is provided a management system comprising a printing machine, a user terminal, a management apparatus, a substitute printing machine and a maintenance terminal connected to one another over an external network.

In the management system, the printing machine generates trouble information indicating contents of a trouble occurred and transmits the generated trouble information to the management apparatus, and

the management apparatus receives the trouble information sent from the printing machine, discriminates whether urgent maintenance for the printing machine is needed or not in accordance with the received trouble information, transmits substitution information of the substitute printing machine to be a substitute output destination to the user terminal which is using the printing machine, when it is discriminated that the urgent maintenance is needed, and transmits instruction information instructing collection of a target print to be printed by the substitute printing machine and urgent maintenance to the maintenance terminal in accordance with transmission of the substitution information.

This management system can likewise adequately improve the availability factor of printing machines by instructing necessary maintenance.

The management apparatus may memorize, beforehand, a driver program which is to be run by the printing machine, and install the driver program in the user terminal.

The management apparatus may memorize maintenance field information indicating a field of maintenance which is carried out by a maintenance person who uses a maintenance terminal, specify the maintenance terminal of the maintenance person who maintains the printing machine, when it is discriminated that the urgent maintenance is needed, based on contents of the urgent maintenance discriminated as necessary and the maintenance field information, and transmit instruction information to the specified maintenance terminal.

According to the third aspect of the invention, there is provided a machine management apparatus which is connected to an external printing machine and an external maintenance terminal over an external network. The machine management apparatus has:

a communication control device that receives use information sent from the printing machine; and

a processor that discriminates whether preventive maintenance for the printing machine is needed or not in accordance with the use information received by the communication control device, and generates instruction information instructing preventive maintenance to the maintenance terminal when it is discriminated that the preventive maintenance is needed,

whereby the communication control device transmits the instruction information to the maintenance terminal.

This machine management apparatus can likewise adequately improve the availability factor of printing machines by instructing necessary maintenance.

The machine management apparatus may further have a memory which stores maintenance field information indicating a field of maintenance which is carried out by a maintenance person who uses a maintenance terminal, and

when having discriminated that the preventive maintenance is needed, the processor may specify the maintenance terminal of the maintenance person who maintains the printing machine, based on contents of the preventive maintenance discriminated as necessary and the maintenance field information. In this case, the communication control device should transmit instruction information to the specified maintenance terminal.

According to the fourth aspect of the invention, there is provided a machine management apparatus which is connected to an external printing machine, an external user terminal an external substitute printing machine and an external maintenance terminal over an external network. The machine management apparatus has:

a communication control device that receives trouble information sent from the printing machine; and

a processor that discriminates whether urgent maintenance for the printing machine is needed or not in accordance with the trouble information received by the communication control device, generates substitution information of the substitute printing machine, which is to be a substitute output destination and is to be transmitted to the user terminal which is using the printing machine, when it is discriminated that the urgent maintenance is needed, and generates instruction information instructing collection of a target print to be printed by the substitute printing machine and urgent maintenance in accordance with transmission of the substitution information,

whereby the communication control device transmits the substitution information to the user terminal which is using the printing machine and transmits the instruction information to the maintenance terminal.

This machine management system can likewise adequately improve the availability factor of printing machines by instructing necessary maintenance.

The machine management apparatus may further have a memory which stores maintenance field information indicating a field of maintenance which is carried out by a maintenance person who uses a maintenance terminal, and

when having discriminated that the urgent maintenance is needed, the processor may specify the maintenance terminal of the maintenance person who maintains the printing machine, based on contents of the urgent maintenance discriminated as necessary and the maintenance field information. In this case, the communication control device should transmit instruction information to the specified maintenance terminal.

According to the fifth aspect of the invention, there is provided a maintenance work instructing method in an apparatus connected to a printing machine, a user terminal, a substitute printing machine and a maintenance terminal over a network. The method comprises:

a use information receiving step which receives use information sent from the printing machine;

a discrimination step which discriminates whether preventive maintenance for the printing machine is needed or not in accordance with the use information received in the use information receiving step; and

an instruction information transmitting step which transmits instruction information instructing preventive maintenance to the maintenance terminal when it is discriminated in the discrimination step that the preventive maintenance is needed.

This maintenance work instructing method can likewise adequately improve the availability factor of printing machines by instructing necessary maintenance.

According to the sixth aspect of the invention, there is provided a maintenance work instructing method in an apparatus connected to a printing machine, a user terminal, a substitute printing machine and a maintenance terminal over a network. The method comprises:

a trouble information receiving step which receives trouble information sent from the printing machine;

a discrimination step which discriminates whether urgent maintenance for the printing machine is needed or not in accordance with the trouble information received in the trouble information receiving step;

a substitution information transmitting step which transmits substitution information of the substitute printing machine to be a substitute output destination to the user terminal which is using the printing machine, when it is discriminated that the urgent maintenance is needed; and

an instruction information transmitting step which transmits instruction information instructing collection of a target print to be printed by the substitute printing machine and urgent maintenance to the maintenance terminal in accordance with transmission of the substitution information in the substitution information transmitting step.

This maintenance work instructing method can likewise adequately improve the availability factor of printing machines by instructing necessary maintenance.

According to the seventh aspect of the invention, there is provided a computer readable recording medium having a program recorded therein that allows a computer having a communication control device to function as a machine management apparatus which is connected to an external printing machine and an external maintenance terminal over an external network and which:

receives use information sent from the printing machine;

discriminates whether preventive maintenance for the printing machine is needed or not in accordance with the use information received by the communication control device, and generates instruction information instructing preventive maintenance to the maintenance terminal when it is discriminated that the preventive maintenance is needed; and

transmits the instruction information to the maintenance terminal.

The computer which runs a program recorded in such a recording medium can likewise adequately improve the availability factor of printing machines by instructing necessary maintenance.

According to the eighth aspect of the invention, there is provided a computer readable recording medium having a program recorded therein that allows a computer having a communication control device to function as a machine management apparatus which is connected to an external printing machine, an external user terminal, an external substitute printing machine and an external maintenance terminal over an external network and which:

receives trouble information sent from the printing machine;

discriminates whether urgent maintenance for the printing machine is needed or not in accordance with the trouble information received by the communication control device;

generates substitution information of the substitute printing machine, which is to be a substitute output destination and is to be transmitted to the user terminal which is using the printing machine, when it is discriminated that the urgent maintenance is needed;

generates instruction information instructing collection of a target print to be printed by the substitute printing machine and urgent maintenance in accordance with transmission of the substitution information;

transmits the substitution information to the user terminal which is using the printing machine; and

transmits the instruction information to the maintenance terminal.

The computer which runs a program recorded in such a recording medium can likewise adequately improve the availability factor of printing machines by instructing necessary maintenance.

According to the ninth aspect of the invention, there is provided a data signal buried in a carrier and expressing a program that allows a computer having a communication control device to function as a machine management apparatus which is connected to an external printing machine and an external maintenance terminal over an external network and which:

receives use information sent from the printing machine;

discriminates whether preventive maintenance for the printing machine is needed or not in accordance with the use information received by the communication control device, and generates instruction information instructing preventive maintenance to the maintenance terminal when it is discriminated that the preventive maintenance is needed; and

transmits the instruction information to the maintenance terminal.

The computer which runs a program expressed by such a program data signal can likewise adequately improve the availability factor of printing machines by instructing necessary maintenance.

According to the tenth aspect of the invention, there is provided a computer data signal buried in a carrier and expressing a program that allows a computer having a communication control device to function as a machine management apparatus which is connected to an external printing machine, an external user terminal, an external substitute printing machine and an external maintenance terminal over an external network and which:

receives trouble information sent from the printing machine;

discriminates whether urgent maintenance for the printing machine is needed or not in accordance with the trouble information received by the communication control device;

generates substitution information of the substitute printing machine, which is to be a substitute output destination and is to be transmitted to the user terminal which is using the printing machine, when it is discriminated that the urgent maintenance is needed;

generates instruction information instructing collection of a target print to be printed by the substitute printing machine and urgent maintenance in accordance with transmission of the substitution information;

transmits the substitution information to the user terminal which is using the printing machine; and

transmits the instruction information to the maintenance terminal.

The computer which runs a program expressed by such a program data signal can likewise adequately improve the availability factor of printing machines by instructing necessary maintenance.

### BRIEF DESCRIPTION OF THE DRAWINGS

These objects and other objects and advantages of the present invention will become more apparent upon reading of the following detailed description and the accompanying drawings in which:

FIG. 1 is an exemplary diagram illustrating one example of the structure of a management system according to one embodiment of the present invention;

FIG. 2 is a block diagram illustrating one example of the structure of a printing machine;

FIG. 3A is an exemplary diagram illustrating one example of use information to be stored in a machine information data base;

FIG. 3B is an exemplary diagram illustrating one example of trouble information to be stored in the machine information data base;

FIG. 3C is an exemplary diagram illustrating one example of threshold value information to be stored in the machine information data base;

FIG. 4 is a flowchart illustrating the use information transmitting/receiving operation of the management system according to the embodiment of the invention; and

FIG. 5 is a flowchart illustrating the trouble information transmitting/receiving operation of the management system according to the embodiment of the invention.

### DETAILED DESCRIPTION OF THE PREFERRED EMBODIMENT

A management system according to one embodiment of the present invention is described below with reference to the accompanying drawings.

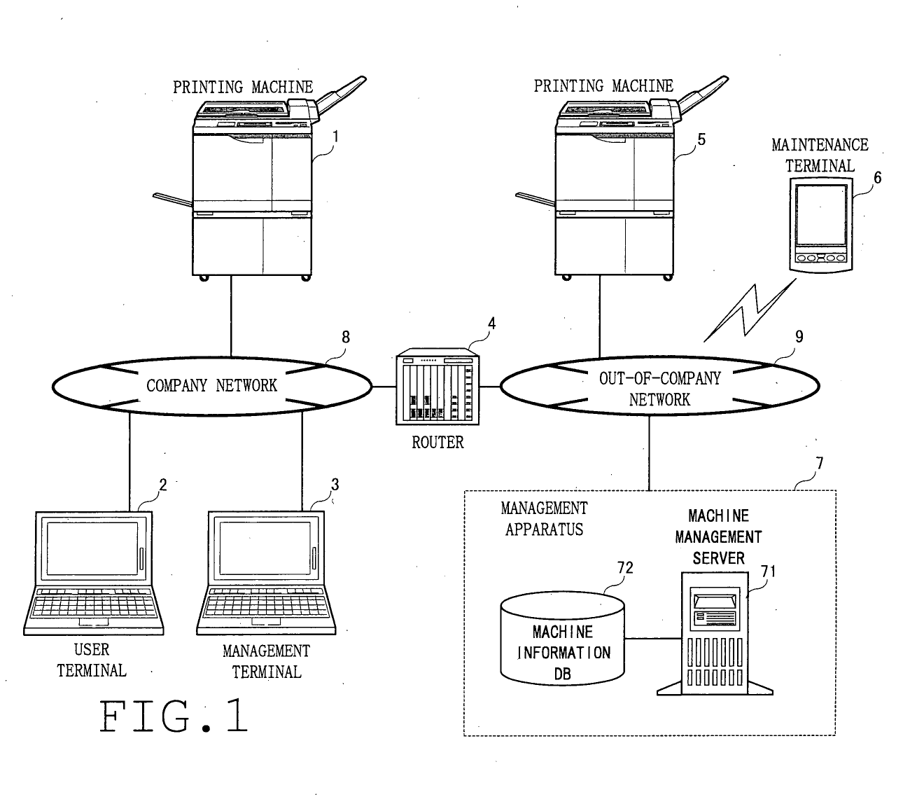

FIG. 1 is an exemplary diagram illustrating one example of the structure of a management system according to the embodiment of the invention. As illustrated, the system comprises printing machines 1 and 5, a user terminal 2, a management terminal 3, a router 4, a maintenance terminal 6 and a management apparatus 7.

The printing machine 1, user terminal 2 and management terminal 3 are connected to a company network 8. The printing machine 5, maintenance terminal 6 and management apparatus 7 are connected to an out-of-company network 9.

The company network 8 is comprised of a communication circuit, such as LAN, and the out-of-company network 9 is comprised of a communication circuit, such as the Internet.

The printing machine 1, which is comprised of a multifunction machine, a copying machine or so, is operated by a user to perform a printing operation: copying and printing texts, images, etc. The printing machine 1 is placed in, for example, an office or so in a company.

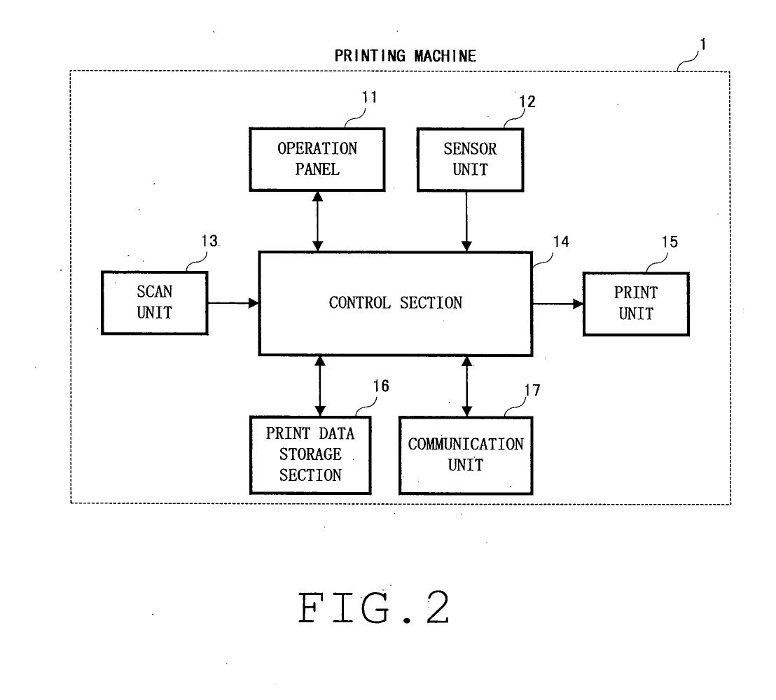

Specifically, the printing machine 1 comprises an operation panel 11, a sensor unit 12, a scan unit 13, a control section 14, a print unit 15, a print data storage section 16 and a communication unit 17, as shown in FIG. 2.

The operation panel 11 is comprised of, for example, a plurality of button switches and a display device such as a liquid crystal display. The operation panel 11 supplies the control section 14 with data according to an operation done by a user, and displays the operational status and the set conditions or so of the printing machine 1 under the control of the control section 14.

The sensor unit 12, which comprises a plurality of sensors or so located at predetermined positions in the printing machine 1, detects the operational status of the printing machine 1 and the occurrence of a trouble. Specifically, the sensor unit 12 counts the number of sheets (number of printouts) copied or printed out by the print unit 15, for example. The sensor unit 12 also detects the occurrence of light troubles, such as jamming (paper jamming) and the out-of-toner state and the occurrence of critical troubles, such as system malfunction and missing of parts.

The sensor unit 12 generates data indicating the results of detection of the operational status of the printing machine 1, the occurrence of a trouble, etc., and sends the data to the control section 14 one after another or at a given timing.

The scan unit 13 is comprised of, for example, a CCD (Charge Coupled Device) sensor and a manuscript table having a transparent window. The scan unit 13 scans a document or so placed on the manuscript table with light or so and generates image data of the scanned document or so. The scan unit 13 supplies the generated image data to the print data storage section 16 or the print unit 15.

The control section 14, comprised of a CPU (Central Processing Unit), a peripheral LSI (Large Scale Integration), etc., controls the individual sections of the printing machine 1.

Specifically, the control section 14 causes the print unit 15 or so to perform a printing operation according to an operation done by the user in accordance with a program stored in an unillustrated nonvolatile memory or so. In accordance with this program, the control section 14 also executes a use information transmitting process and a trouble information transmitting process, which will be discussed later.

The print unit 15 is comprised of a unit which transfers toner onto a given sheet by using, for example, a photosensitive drum or so, and fixes the toner.

The print unit 15 prints on a given sheet (e.g., paper) texts and figures or so expressed by image data supplied from the scan unit 13 or texts and figures or so expressed by data stored in the print data storage section 16.

The print data storage section 16, comprised of a memory such as RAM (Random Access Memory), temporarily stores print data sent from the user terminal 2 through the communication unit 17. The print data storage section 16 also stores image data supplied from the scan unit 13.

The communication unit 17 is comprised of a communication control device, specifically, an Ethernet (registered trademark) interface circuit or a modem or so.

The communication unit 17 receives print data sent from the user terminal 2 over the company network 8 and transmits and receives predetermined information to and from the management apparatus 7 over the out-of-company network 9 through the router 4.

For example, the communication unit 17 transmits use information (to be discussed later), generated by the control section 14 when the print unit 15 makes a copy or printout, to the management apparatus 7. Further, the communication unit 17 transmits trouble information (to be discussed later), generated by the control section 14 when the a trouble occurs, to the management apparatus 7.

Returning to FIG. 1, the user terminal 2 is comprised of a general-purpose personal computer or so which includes a processor, a hard disk, memory, input device and communication control device.

The user terminal 2 executes an application program, stored locally, on a predetermined operating system according to the operation of a user or so who uses the printing machine 1, generates various kinds of print data and transmits the data to the printing machine 1.

The management terminal 3 is comprised of a personal computer whose structure is similar to the structure of the user terminal 2.

The management terminal 3 executes a program, stored locally, according to the operation of a manager or so who manages the printing machine 1. According to the program, the management terminal 3 receives communication information on preventive maintenance or information on a substitute output destination sent from the management apparatus 7. In accordance with this program, the management terminal 3 may receive a driver program of the printing machine 5 to be the substitute output destination from the management apparatus 7 and install the received driver program in the user terminal 2 or so.

The router 4 is comprised of a communication control device which controls the transfer path for data, and relays communications between the company network 8 and the out-of-company network 9. Specifically, the router 4 transfers use information or so, sent from the printing machine 1 on the company network 8, to the management apparatus 7 on the out-of-company network 9. The router 4 also transfers communication information of preventive maintenance, sent from the management apparatus 7 over the out-of-company network 9, to the management apparatus 7 on the company network 8.

The printing machine 5 is comprised of a multifunction machine or a copying machine or so which has a structure similar to that of the printing machine 1, and is placed in, for example, a maintenance center or so of a company.

When a critical trouble has occurred in the printing machine 1, the printing machine 5 receives print data sent from the user terminal 2 and prints it on a given sheet.

The printing machine 5 may be designed in such a way as to inhibit a third party including a maintenance person from seeing the print contents. For example, the printing machine 5 may have a function to place a series of printed sheets in an opaque bag or so and discharge it.

The maintenance terminal 6, which is comprised of, for example, a general-purpose portable terminal (PDA or portable cell phone or so) which has a radio communication capability, is used by a maintenance person who maintains the printing machine 1.

The maintenance terminal 6 radio-communicates predetermined data with the management apparatus 7. Specifically, the maintenance terminal 6 receives instruction information (information instructing preventive maintenance or urgent maintenance of the printing machine 1) sent from the management apparatus 7 and displays the information on its own display section. It is assumed that the maintenance terminal 6 and the management apparatus 7 are connected to each other over the out-of-company network 9 via an unillustrated predetermined wireless access point.

The management apparatus 7, which is placed outside the building of a company, for example, and comprises a machine management server 71 and a machine information data base 72.

The machine management server 71 is comprised of a predetermined server unit equipped with, for example, a processor, memory and communication control device or so. The machine management server 71 also has, for example, a timer which continuously generates information indicating a current date or acquires it from outside.

The machine management server 71 executes a use information receiving process to be discussed later and instructs the maintenance terminal 6 (maintenance person) to do preventive maintenance of the printing machine 1. The machine management server 71 also executes a trouble information receiving process to be discussed later and transmits information about the printing machine 5 to be a substitute output destination to the management terminal 3 when a critical trouble has occurred.

The machine information data base 72, which is comprised of a nonvolatile memory such as a hard disk, stores use information and trouble information sent from the printing machine 1.

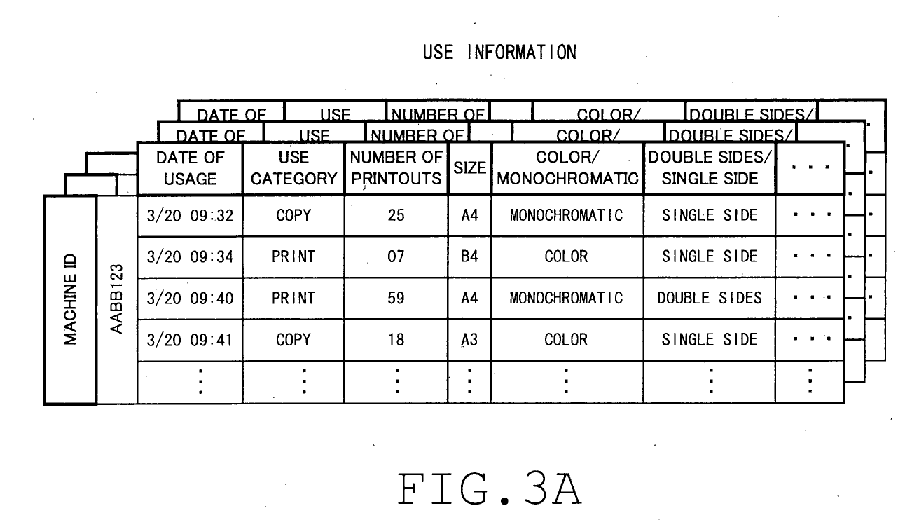

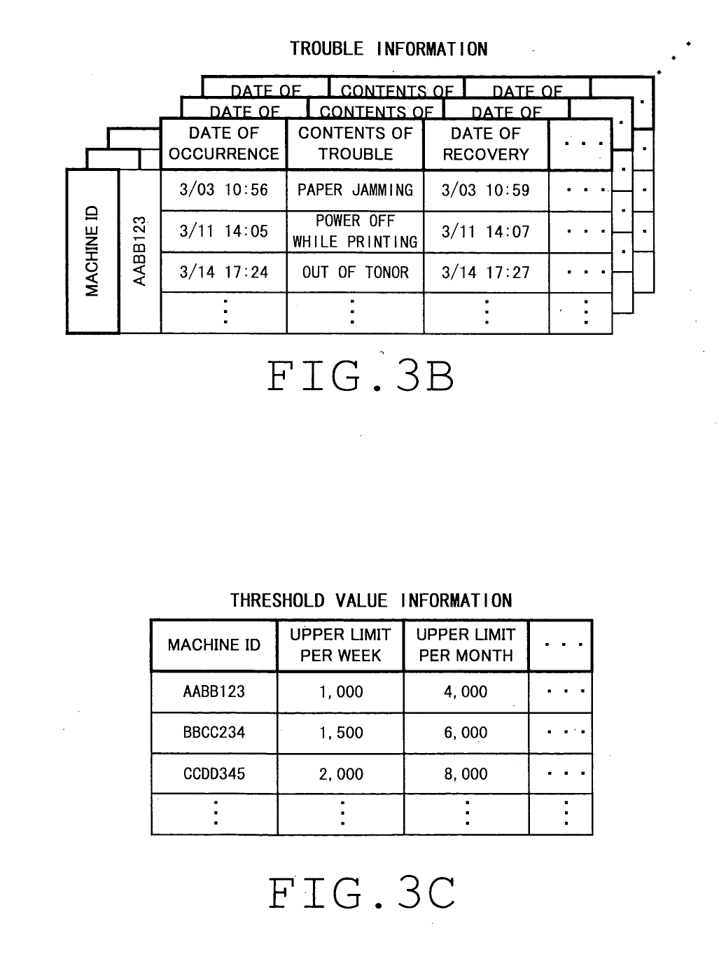

Specifically, the machine information data base 72 stores use information as shown in FIG. 3A or trouble information as shown in FIG. 3B.

The use information is used at the time of counting the number of printouts from the printing machine 1. As illustrated, for example, the use information includes information such as the date of usage, use category (i.e., distinction between copy and print), the number of printouts, the sheet size, distinction between color and monochromatic, and distinction between one side or double sides, in association with one another for the same use opportunity.

The trouble information is used to grasp the contents of a trouble occurred and is used to quantitatively acquire the availability factor of the printing machine 1. As illustrated, for example, the trouble information includes information, such as the date of the occurrence of a trouble, the contents of the trouble, and the date of recovery from the trouble in association with one another for the same trouble.

The machine information data base 72 stores threshold value information which is a reference line to do preventive maintenance of the printing machine 1.

Specifically, the machine information data base 72 stores threshold value information as shown in FIG. 3C beforehand. That is, the threshold value information includes information, such as the ID (Identification code) of the machine, the upper limit (upper limit per week) of printouts permitted to be made in a week and the upper limit (upper limit per month) of printouts permitted to be made in a month, in association with one another for the same printing machine.

The operation of the management system according to the embodiment is discussed below referring to the drawings.

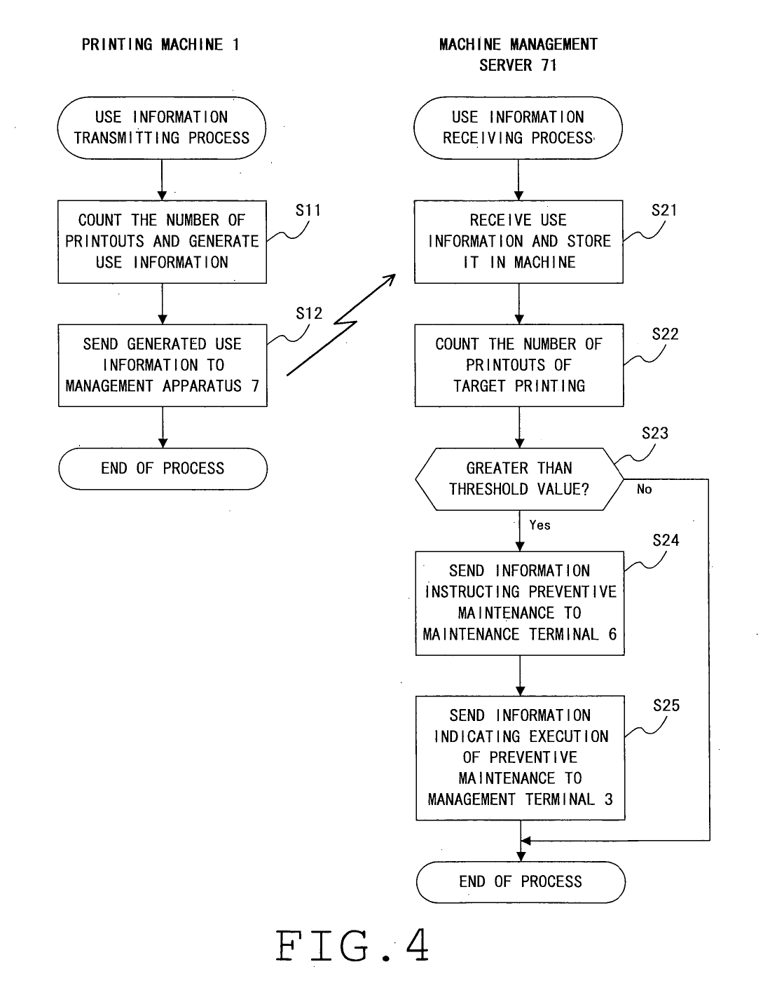

To begin with, an operation to grasp the use status of the printing machine 1 is discussed below referring to FIG. 4. FIG. 4 is a flowchart illustrating one example of the use information transmitting process that is executed by the printing machine 1 and the use information receiving process that is executed by the machine management server 71 (management apparatus 7).

The use information transmitting process is automatically executed every time the printing machine 1 performs the printing (copying or printing) operation.

When the printing machine 1 performs the printing operation, the printing machine 1 counts the number of printouts and generates use information (step S11).

Then, the printing machine 1 sends the generated use information to the management apparatus 7 (step S12).

Meanwhile, the machine management server 71 (management apparatus 7) receives use information sent from the printing machine 1 and stores it in the machine information data base 72 (step S21). That is, the machine management server 71 adds the received use information to the use information shown in FIG. 3A.

Then, the machine management server 71 counts the number of printouts of the target printing machine 1 (step S22). For example, the machine management server 71 computes the total number of printouts in this week and the total number of printouts in this month from the use information shown in FIG. 3A.

The machine management server 71 determines whether or not the counted number of printouts is greater than the threshold value indicated by the threshold value information (step S23).

When the counted total value for this week (the total number of printouts for this week) exceeds the upper limit of the number of printouts per week (the upper limit of the number of printouts per week for the printing machine 1) shown in FIG. 3C or when the counted total value for this month exceeds the upper limit of the number of printouts per month shown in FIG. 3C, for example, the machine management server 71 decides that the counted number of printouts is greater than the threshold value.

When the machine management server 71 decides that the counted number of printouts is equal to or smaller than the threshold value, the machine management server 71 terminates the use information receiving process as it is.

When the machine management server 71 decides that the counted number of printouts is greater than the threshold value, on the other hand, the machine management server 71 sends information instructing preventive maintenance to the maintenance terminal 6 (step S24). That is, a trouble is likely to occur in the printing machine 1 whose mount of usage evaluated by the number of printouts has exceeded the threshold value, so that an instruction for preventive maintenance of the printing machine 1 is given to the maintenance person who is using the maintenance terminal 6 in order to prevent the trouble.

Then, the machine management server 71 sends information indicating that preventive maintenance is to be executed to the management terminal 3 (step S25).

In other words, preventive maintenance on the printing machine 1 is reported to a manager before a trouble occurs.

Through the execution of the individual processes described referring to FIG. 4, preventive maintenance which becomes necessary is instructed to the maintenance person in accordance with the use state of the printing machine 1. As preventive maintenance on the printing machine 1 is carried out at the adequate timing, the occurrence of a trouble in the printing machine 1 can be prevented, thereby improving the availability factor of the printing machine 1.

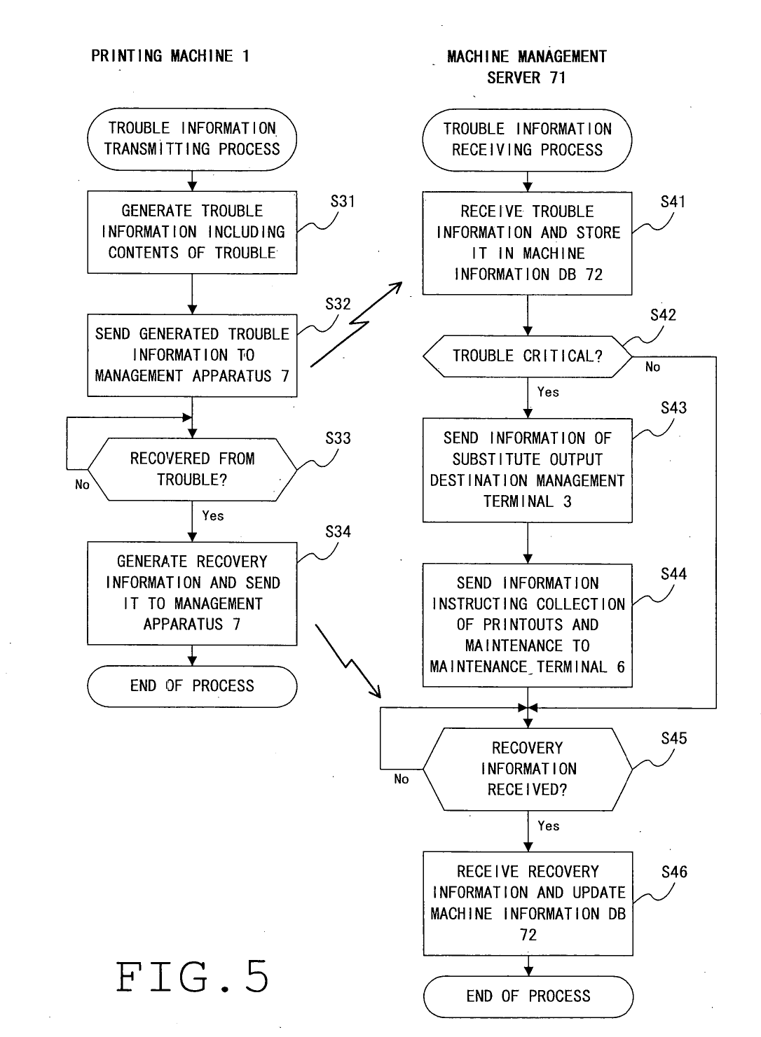

Next, an operation to grasp the trouble status of the printing machine 1 is discussed below referring to FIG. 5. FIG. 5 is a flowchart illustrating one example of the trouble information transmitting process that is executed by the printing machine 1 and the trouble information receiving process that is executed by the machine management server 71 (management apparatus 7).

The trouble information transmitting process is automatically executed every time a trouble occurs in the printing machine.

When the printing machine 1 detects the occurrence of some sort of trouble, the printing machine 1 generates trouble information including the contents of the trouble (step S31). Then, the printing machine 1 sends the generated trouble information to the management apparatus 7 (step S32). Then, the printing machine 1 stands by until the trouble is recovered (step S33).

When a light trouble, such as paper jamming or out of toner, for example, the printing machine 1 displays an instruction image indicating the necessary action for trouble recovery on the display section of the operation panel 11. Then, when the user (or manager) takes the necessary action, the trouble is recovered.

When a predetermined critical trouble, such as system malfunction or missing of parts, occurs, the printing machine 1 detects that the trouble is critical, for example, and displays a message indicating the occurrence of a critical trouble on the display section of the operation panel 11. When the management apparatus 7 instructs urgent maintenance to the maintenance terminal 6 and a maintenance person in charge takes the necessary action, the trouble is recovered as will be discussed later.

Meanwhile, the machine management server 71 (management apparatus 7) receives trouble information sent from the printing machine 1 and stores it in the machine information data base 72 (step S41). That is, the machine management server 71 adds the received trouble information to the trouble information shown in FIG. 3B. It is to be noted that the item on the date of recovery is left blank in step S41.

Then, the machine management server 71 determines whether the trouble occurred in the printing machine 1 is critical or not (step S42). When the trouble contents of the trouble information indicate a predetermined abnormality, such as system malfunction or missing of parts, for example, the machine management server 71 determines that the trouble is critical. When the trouble contents indicate paper jamming, out of toner or so, the machine management server 71 determines that the trouble is not heavy. When the printing machine 1 detects itself that the trouble is critical, the printing machine 1 may generate information indicating that the trouble is critical and send the information to the management apparatus 7. In this case, the machine management server 71 should make the decision in step S42 based on this information.

When the machine management server 71 decides that the trouble occurred is not critical, i.e., that it is a light one, the machine management server 71 proceeds to step S45 to be discussed later.

When the machine management server 71 decides that the trouble occurred is critical, on the other hand, the machine management server 71 sends information of a substitute output destination to the management terminal 3 (step S43).

For example, the machine management server 71 sends information of the IP address of the printing machine 5 or the name of the machine or so to the management terminal 3. The machine management server 71 may further send the driver program or so of the printing machine 5 to the management terminal 3.

When the information of the substitute output destination is transmitted to the management terminal 3, the manager operates, for example, the management terminal 3 to access the user terminal 2 and change the set printer of the user terminal 2 to the printing machine 5 so that print data can be transmitted to the printing machine 5 from the user terminal 2. In case where it is necessary to install the driver program or so of the printing machine 5 in the user terminal 2, the driver program or so received from the management apparatus 7 may be installed in the user terminal 2.

Then, the user terminal 2 sends the print data to the printing machine 5 which in turn prints texts and/or figures on a given sheet. At this time, for example, the printing machine 5 places a series of printed sheets in an opaque bag or so and discharges it.

Meanwhile, the machine management server 71 transmits instruction information instructing collection of printouts and urgent maintenance to the maintenance terminal 6 (step S44).

That is, when the print data sent from the user terminal 2 is printed by the printing machine 5, the maintenance person is instructed to collect the printout and do urgent maintenance on the printing machine 1.

In accordance with the instruction, the maintenance person collects the sheets printed by the printing machine 5 (those which are placed in an opaque bag or so), and goes for the urgent maintenance of the printing machine 1. Then, the maintenance person hands the collected printout to the manager (or user) and starts the urgent maintenance of the printing machine 1.

Thereafter, the machine management server 71 stops the execution of subsequent processes and stands by until it receives recovery information sent from the printing machine 1 (step S45).

When the trouble is recovered, the printing machine 1 which has waited for trouble recovery generates recovery information and sends it to the management apparatus 7 (step S34).

Meanwhile, when receiving the recovery information from the printing machine 1, the machine management server 71 updates the machine information data base 72 according to the received recovery information (step S46). Specifically, the machine management server 71 adds the current date at the time of reception of the recovery information as the date of recovery to the trouble information added in step S41.

Through the individual processes explained referring to FIG. 5, therefore, the management terminal 3 is informed of the substitute output destination that becomes necessary depending on the trouble state of the printing machine 1 and substitute printing from the printing machine 5 can be done through the user terminal 2. Then, the maintenance person is instructed to collect the printout and do urgent maintenance and the maintenance person who has brought the printout made by the printing machine 5 does urgent maintenance of the printing machine 1.

Accordingly, the adequate action can be taken even when a trouble occurs in the printing machine 1.

Although the foregoing description of the embodiment has been given of the case where the printing machine 5 to be a substitute output destination of the printing machine 1 is placed in the maintenance center or so, any printing machine placed in a predetermined shop or so (printing machine which can be used from outside) may be the substitute output destination.

For example, the machine management server 71 previously stores information of shops or so where printing machines usable from outside are located and retrieves a shop or so nearest to the company (office or so) of the user at the time of selecting the substitute output destination of the printing machine 1. Then, the machine management server 71 transmits information indicating the printing machine in the retrieved shop as a substitute output destination to the management terminal 3.

This management system may have a plurality of maintenance terminals 6 for the respective maintenance persons. For each of the maintenance terminals 6, the management apparatus 7 may memorize information for identifying the maintenance terminal 6 and information indicating the field of specialty of the maintenance person who uses the maintenance terminal 6. In case of transmitting the instruction information, the management apparatus 7 may specify the maintenance terminal 6 which is used by the maintenance person whose field of specialty matches with the handling of an occurred trouble or an event indicating the number of printouts exceeding the threshold value, and may transmit the instruction information to the specified maintenance terminal 6.

The management system according to the invention can be achieved not only by a special system but also an ordinary computer system.

For example, the management system which executes the above-described processes can be constructed by installing a plurality of programs for performing the operations of the user terminal 2, the management terminal 3, the maintenance terminal 6 and the management apparatus 7, stored in a medium (CD-ROM, MO or so), into a plurality of computers connected to a network via communication control devices and connected to the printing machines over the network.

Alternatively, those programs may be uploaded to a bulletin board system (BBS) of a communication circuit and distributed through the communication circuit, or a carrier may be modulated with signals expressing those programs, and the acquired modulated wave may be demodulated to restore the programs by an apparatus which receives the modulated waves.

As those programs are activated and run, like other application programs, under the control of the OS, the above-described processes can be carried out.

In case where the OS carries out parts of the processes, or the OS constitutes a part of a single constituting element of the present invention, those programs excluding the part may be stored in the recording medium. Even in this case, it is premised that the programs for executing the individual functions or steps that are executed by a computer should be stored in the recording medium in the invention.

As described above, the invention can adequately improve the availability factor of printing machines by instructing necessary maintenance.

Various embodiments and changes may be made thereonto without departing from the broad spirit and scope of the invention. The above-described embodiment is intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application claims the priority of Japanese Patent Application No. 2003-92755 filed on Mar. 28, 2003 at the Japanese Patent Office, which is incorporated herein by reference.

What is claimed is:

1. A management system comprising a printing machine, a management apparatus and a maintenance terminal connected to one another over an external network, wherein
said printing machine generates use information indicating contents of a printing operation and transmits said generated use information to said management apparatus, and
said management apparatus receives said use information sent from said printing machine, discriminates whether preventive maintenance for said printing machine is needed or not in accordance with said received use information, and transmits instruction information instructing preventive maintenance to said maintenance terminal when it is discriminated that said preventive maintenance is needed.

2. The management system according to claim 1, wherein
said use information generated by said printing machine includes number-of-printouts information indicating a number of sheets printed by said printing operation, and
said management apparatus memorizes a threshold value of a predetermined number of printouts in association with said printing machine, and discriminates whether or not preventive maintenance for said printing machine is needed based on a quantity indicated by said number-of-printouts information included in said use information received by said management apparatus and said threshold value memorized by said management apparatus.

3. The management system according to claim 1, wherein said management apparatus memorizes maintenance field information indicating a field of maintenance which is carried out by a maintenance person who uses a maintenance terminal, specifies said maintenance terminal of said maintenance person who maintains said printing machine, when it is discriminated that said preventive maintenance is needed, based on contents of said preventive maintenance discriminated as necessary and said maintenance field information, and transmits instruction information to said specified maintenance terminal.

4. A management system comprising a printing machine, a user terminal, a management apparatus, a substitute printing machine and a maintenance terminal connected to one another over an external network, wherein
said printing machine generates trouble information indicating contents of a trouble occurred and transmits said generated trouble information to said management apparatus, and
said management apparatus receives said trouble information sent from said printing machine, discriminates whether urgent maintenance for said printing machine is needed or not in accordance with said received trouble information, transmits substitution information of said substitute printing machine to be a substitute output destination to said user terminal which is using said printing machine, when it is discriminated that said urgent maintenance is needed, and transmits instruction information instructing collection of a target print to be printed by said substitute printing machine and urgent maintenance to said maintenance terminal in accordance with transmission of said substitution information.

5. The management system according to claim 4, wherein said management apparatus memorizes, beforehand, a driver program which is to be run by said printing machine, and installs said driver program in said user terminal.

6. The management system according to claim 4, wherein said management apparatus memorizes maintenance field information indicating a field of maintenance which is carried out by a maintenance person who uses a maintenance terminal, specifies said maintenance terminal of said maintenance person who maintains said printing machine, when it is discriminated that said urgent maintenance is needed, based on contents of said urgent maintenance discriminated as necessary and said maintenance field information, and transmits instruction information to said specified maintenance terminal.

7. A machine management apparatus which is connected to an external printing machine and an external maintenance terminal over an external network and has:
a communication control device that receives use information sent from said printing machine; and
a processor that discriminates whether preventive maintenance for said printing machine is needed or not in accordance with said use information received by said communication control device, and generates instruction information instructing preventive maintenance to said maintenance terminal when it is discriminated that said preventive maintenance is needed,
whereby said communication control device transmits said instruction information to said maintenance terminal.

8. The machine management apparatus according to claim 7, further having a memory which stores maintenance field information indicating a field of maintenance which is carried out by a maintenance person who uses a maintenance terminal, and wherein
when having discriminated that said preventive maintenance is needed, said processor specifies said maintenance terminal of said maintenance person who maintains said printing machine, based on contents of said preventive maintenance discriminated as necessary and said maintenance field information, and
said communication control device transmits instruction information to said specified maintenance terminal.

9. A machine management apparatus which is connected to an external printing machine, an external user terminal, an external substitute printing machine and an external maintenance terminal over an external network and is comprised of:
a communication control device that receives trouble information sent from said printing machine; and
a processor that discriminates whether urgent maintenance for said printing machine is needed or not in accordance with said trouble information received by said communication control device, generates substitution information of said substitute printing machine, which is to be a substitute output destination and is to be transmitted to said user terminal which is using said printing machine, when it is discriminated that said urgent maintenance is needed, and generates instruction information instructing collection of a target print to be printed by said substitute printing machine and urgent maintenance in accordance with transmission of said substitution information,
whereby said communication control device transmits said substitution information to said user terminal which is using said printing machine and transmits said instruction information to said maintenance terminal.

10. The machine management apparatus according to claim 9, further having a memory which stores maintenance field information indicating a field of maintenance which is carried out by a maintenance person who uses a maintenance terminal, and wherein
when having discriminated that said urgent maintenance is needed, said processor specifies said maintenance terminal of said maintenance person who maintains said printing machine, based on contents of said urgent maintenance discriminated as necessary and said maintenance field information, and
said communication control device transmits instruction information to said specified maintenance terminal.

11. A maintenance work instructing method in an apparatus connected to a printing machine, a user terminal, a substitute printing machine and a maintenance terminal over a network, comprising:
a use information receiving step which receives use information sent from said printing machine;
a discrimination step which discriminates whether preventive maintenance for said printing machine is needed or not in accordance with said use information received in said use information receiving step; and
an instruction information transmitting step which transmits instruction information instructing preventive maintenance to said maintenance terminal when it is discriminated in said discrimination step that said preventive maintenance is needed.

12. A maintenance work instructing method in an apparatus connected to a printing machine, a user terminal, a substitute printing machine and a maintenance terminal over a network, comprising:
a trouble information receiving step which receives trouble information sent from said printing machine;
a discrimination step which discriminates whether urgent maintenance for said printing machine is needed or not in accordance with said trouble information received in said trouble information receiving step;
a substitution information transmitting step which transmits substitution information of said substitute printing machine to be a substitute output destination to said user terminal which is using said printing machine, when it is discriminated that said urgent maintenance is needed; and
an instruction information transmitting step which transmits instruction information instructing collection of a target print to be printed by said substitute printing machine and urgent maintenance to said maintenance terminal in accordance with transmission of said substitution information in said substitution information transmitting step.

13. A computer readable recording medium having a program recorded therein that allows a computer having a communication control device to function as a machine management apparatus which is connected to an external printing machine and an external maintenance terminal over an external network and which:
receives use information sent from said printing machine;
discriminates whether preventive maintenance for said printing machine is needed or not in accordance with said use information received by said communication control device, and generates instruction information instructing preventive maintenance to said maintenance terminal when it is discriminated that said preventive maintenance is needed; and
transmits said instruction information to said maintenance terminal.

14. A computer readable recording medium having a program recorded therein that allows a computer having a communication control device to function as a machine management apparatus which is connected to an external printing machine, an external user terminal, an external substitute printing machine and an external maintenance terminal over an external network and which:
receives trouble information sent from said printing machine;
discriminates whether urgent maintenance for said printing machine is needed or not in accordance with said trouble information received by said communication control device;
generates substitution information of said substitute printing machine, which is to be a substitute output destination and is to be transmitted to said user terminal which is using said printing machine, when it is discriminated that said urgent maintenance is needed;
generates instruction information instructing collection of a target print to be printed by said substitute printing machine and urgent maintenance in accordance with transmission of said substitution information;
transmits said substitution information to said user terminal which is using said printing machine; and
transmits said instruction information to said maintenance terminal.

15. A computer data signal buried in a carrier and expressing a program that allows a computer having a communication control device to function as a machine management apparatus which is connected to an external printing machine and an external maintenance terminal over an external network and which:
receives use information sent from said printing machine;
discriminates whether preventive maintenance for said printing machine is needed or not in accordance with said use information received by said communication control device, and generates instruction information instructing preventive maintenance to said maintenance terminal when it is discriminated that said preventive maintenance is needed; and
transmits said instruction information to said maintenance terminal.

16. A computer data signal buried in a carrier and expressing a program that allows a computer having a communication control device to function as a machine management apparatus which is connected to an external printing machine, an external user terminal, an external substitute printing machine and an external maintenance terminal over an external network and which:
receives trouble information sent from said printing machine;
discriminates whether urgent maintenance for said printing machine is needed or not in accordance with said trouble information received by said communication control device;
generates substitution information of said substitute printing machine, which is to be a substitute output destination and is to be transmitted to said user terminal which is using said printing machine, when it is discriminated that said urgent maintenance is needed;
generates instruction information instructing collection of a target print to be printed by said substitute printing machine and urgent maintenance in accordance with transmission of said substitution information;
transmits said substitution information to said user terminal which is using said printing machine; and
transmits said instruction information to said maintenance terminal.
